(19) United States
(12) Patent Application Publication
(10) Pub. No.: US 2021/0116142 A1
(43) Pub. Date: Apr. 22, 2021

(54) THERMOSTAT AND METHOD USING A NEURAL NETWORK TO ADJUST TEMPERATURE MEASUREMENTS

(71) Applicant: Distech Controls Inc., Brossard (CA)

(72) Inventors: Jean-Simon BOUCHER, Sainte-Julie (CA); Francois GERVAIS, Lachine (CA)

(21) Appl. No.: 16/660,171

(22) Filed: Oct. 22, 2019

(51) Int. Cl. F24F 11/63; F24F 11/523; G06N 3/04

(52) U.S. Cl. CPC F24F 11/63; F24F 2130/30; G06N 3/04; F24F 11/523

(57) ABSTRACT

Computing device and method using a neural network to adjust temperature measurements. The computing device comprises a temperature sensing module, one or more processor and a display. The neural network receives as inputs a plurality of consecutive temperature measurements performed by the temperature sensing module, a plurality of consecutive utilization metrics of the one or more processor, and a plurality of consecutive utilization metrics of the display. The neural network outputs an inferred temperature, which is an adjustment of the temperature measured by the temperature sensing module to take into consideration heat dissipated by the one or more processor and the display when using the temperature sensing module for measuring the temperature in an area where the computing device is deployed. An example of computing device is a smart thermostat. A corresponding method for training a neural network to adjust temperature measurements is also disclosed.

### TECHNICAL FIELD

The present disclosure relates to the field of building automation, and more precisely to smart thermostats. More specifically, the present disclosure presents a thermostat and method using a neural network to adjust temperature measurements.

### BACKGROUND

Systems for controlling environmental conditions, for example in buildings, are becoming increasingly sophisticated. An environment control system may at once control heating and cooling, monitor air quality, detect hazardous conditions such as fire, carbon monoxide release, intrusion, and the like. Such environment control systems generally include at least one environment controller, which receives measured environmental values (generally from external sensors), and in turn determines set-points or command parameters to be sent to controlled appliances.

Legacy equipment used in the context of the environmental control of room(s) of a building have evolved to support new functionalities. For instance, legacy thermostats only provided the functionality to allow a user to adjust the temperature in an area (e.g. in a room). Smart thermostats now also have the capability to read the temperature in the area and display it on a display of the smart thermostat. Furthermore, smart thermostats may have enhanced communication capabilities provided by a communication interface of the following type: Wi-Fi, Bluetooth®, Bluetooth® Low Energy (BLE), etc.

A smart thermostat with the capability to measure the temperature in the area where it is deployed includes a temperature sensing module for performing the temperature measurement. The smart thermostat also includes a processor for controlling the operations of the smart thermostat. The smart thermostat further includes the display for displaying the temperature measured by the temperature sensing module. Operations of the processor and the display dissipate heat, which affect the temperature measured by the temperature sensing module. Thus, the temperature measured by the temperature sensing module of the smart thermostat may be inaccurate, for example when the processor is or has been operating recently (due to the heat dissipated by the processor which increases the temperature measured by the temperature sensing module).

Therefore, there is a need for a thermostat and method using a neural network to adjust temperature measurements.

### SUMMARY

According to a first aspect, the present disclosure relates to a thermostat. The thermostat comprises a temperature sensing module, a display, memory for storing a predictive model comprising weights of a neural network, and a processing unit comprising one or more processor. The processing unit receives a plurality of consecutive temperature measurements from the temperature sensing module. The processing unit determines a plurality of consecutive utilization metrics of the one or more processor of the processing unit. The processing unit determines a plurality of consecutive utilization metrics of the display. The processing unit executes a neural network inference engine using the predictive model for inferring one or more output based on inputs. The inputs comprise the plurality of consecutive temperature measurements, the plurality of consecutive utilization metrics of the one or more processor, and the plurality of consecutive utilization metrics of the display. The one or more output comprises an inferred temperature.

According to a second aspect, the present disclosure relates to a method using a neural network to adjust temperature measurements. The method comprises storing a predictive model comprising weights of the neural network in a memory of a computing device. The method comprises receiving, by a processing unit of the computing device, a plurality of consecutive temperature measurements from a temperature sensing module of the computing device. The processing unit comprises one or more processor. The method comprises determining, by the processing unit of the computing device, a plurality of consecutive utilization metrics of the one or more processor of the processing unit. The method comprises determining, by the processing unit of the computing device, a plurality of consecutive utilization metrics of a display of the computing device. The method comprises executing, by the processing unit of the computing device, a neural network inference engine using the predictive model for inferring one or more output based on inputs. The inputs comprise the plurality of consecutive temperature measurements, the plurality of consecutive utilization metrics of the one or more processor and the plurality of consecutive utilization metrics of the display. The one or more output comprises an inferred temperature.

According to a third aspect, the present disclosure relates to a method for training a neural network to adjust temperature measurements. The method comprises initializing, by a processing unit of a training server, a predictive model comprising weights of the neural network. The method comprises receiving, by the processing unit of the training server via a communication interface of the training server, a plurality of consecutive temperature measurements from a computing device. The plurality of consecutive temperature measurements is performed by a temperature sensing module of the computing device. The method comprises receiving, by the processing unit of the training server via the communication interface of the training server, a plurality of consecutive utilization metrics of one or more processor of the computing device. The method comprises receiving, by the processing unit of the training server via the communication interface of the training server, a plurality of consecutive utilization metrics of a display of the computing device. The method comprises receiving, by the processing unit of the training server via the communication interface of the training server, a sensor temperature measurement from a temperature sensor. The method comprises executing, by the processing unit of the training server, a neural network training engine to adjust the weights of the neural network based on inputs and one or more output. The inputs comprise the plurality of consecutive temperature measurements, the plurality of consecutive utilization metrics of the one or more processor and the plurality of consecutive utilization metrics of the display. The one or more output comprises the sensor temperature measurement.

### BRIEF DESCRIPTION OF THE DRAWINGS

Embodiments of the disclosure will be described by way of example only with reference to the accompanying drawings, in which:

FIGS. 1A and 1B illustrate an environment control system comprising a thermostat embedding a temperature sensing module;

FIGS. 2A and 2B illustrate details of a processing unit of the thermostat of FIGS. 1A and 1B;

FIG. 3 illustrates the influence of CPU utilization on the temperature measured by the temperature sensing module of the thermostat of FIGS. 1A and 1B;

FIGS. 4A and 4B illustrate a method using a neural network to adjust temperature measurements performed by the temperature sensing module of the thermostat of FIGS. 1A and 1B;

FIG. 5A is a schematic representation of a neural network inference engine executed by the thermostat of FIGS. 1A and 1B according to the method of FIGS. 4A and 4B;

FIG. 5B is a detailed representation of a neural network with fully connected hidden layers;

FIG. 5C is a detailed representation of a neural network comprising a 1D convolutional layer;

FIG. 5D is a detailed representation of a neural network comprising a 2D convolutional layer;

FIG. 6 illustrates an environment control system where several thermostats implementing the method illustrated in FIGS. 4A and 4B are deployed;

FIG. 7 illustrates a method for training a neural network to adjust temperature measurements; and

FIG. 8 is a schematic representation of a neural network training engine executed by a training server according to the method of FIG. 7.

### DETAILED DESCRIPTION

The foregoing and other features will become more apparent upon reading of the following non-restrictive description of illustrative embodiments thereof, given by way of example only with reference to the accompanying drawings.

Various aspects of the present disclosure generally address one or more of the problems related to environment control systems for buildings. More particularly, the present disclosure aims at providing solutions for compensating an error in the measurement of a temperature in an area of a building performed by a temperature sensing module integrated to a smart thermostat. The error is due to heat generated by other electronic components of the smart thermostat, such as a processor and a Liquid Crystal Display (LCD). The measured temperature is higher than the “real” temperature in the area due to the generated heat.

The following terminology is used throughout the present specification:
Environment: condition(s) (temperature, pressure, oxygen level, light level, security, etc.) prevailing in a controlled area or place, such as for example in a building.
Environment control system: a set of components which collaborate for monitoring and controlling an environment.
Environmental data: any data (e.g. information, commands) related to an environment that may be exchanged between components of an environment control system.
Environment control device (ECD): generic name for a component of an environment control system. An ECD may consist of an environment controller, a sensor, a controlled appliance, etc.
Environment controller: device capable of receiving information related to an environment and sending commands based on such information.
Environmental characteristic: measurable, quantifiable or verifiable property of an environment (a building). The environmental characteristic comprises any of the following: temperature, pressure, humidity, lighting, CO2, flow, radiation, water level, speed, sound; a variation of at least one of the following, temperature, pressure, humidity and lighting, CO2 levels, flows, radiations, water levels, speed, sound levels, etc., and/or a combination thereof.
Environmental characteristic value: numerical, qualitative or verifiable representation of an environmental characteristic.
Sensor: device that detects an environmental characteristic and provides a numerical, quantitative or verifiable representation thereof. The numerical, quantitative or verifiable representation may be sent to an environment controller.
Controlled appliance: device that receives a command and executes the command. The command may be received from an environment controller.
Environmental state: a current condition of an environment based on an environmental characteristic, each environmental state may comprise a range of values or verifiable representation for the corresponding environmental characteristic.
VAV appliance: a Variable Air Volume appliance is a type of heating, ventilating, and/or air-conditioning (HVAC) system. By contrast to a Constant Air Volume (CAV) appliance, which supplies a constant airflow at a variable temperature, a VAV appliance varies the airflow at a constant temperature.
Area of a building: the expression ‘area of a building’ is used throughout the present specification to refer to the interior of a whole building or a portion of the interior of the building such as, without limitation: a floor, a room, an aisle, etc.

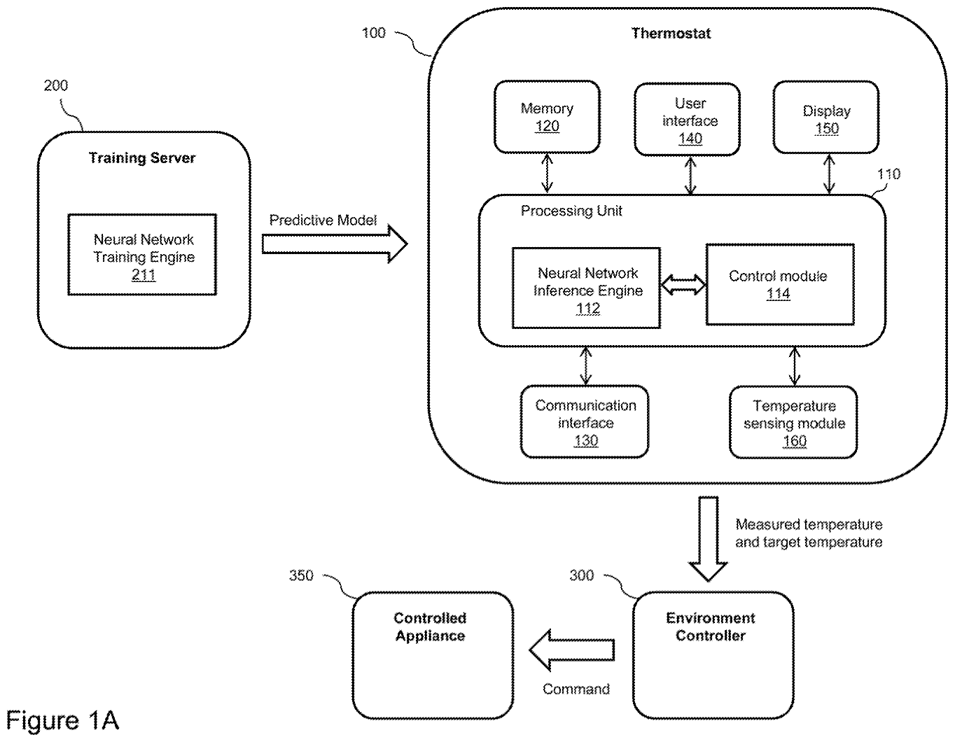

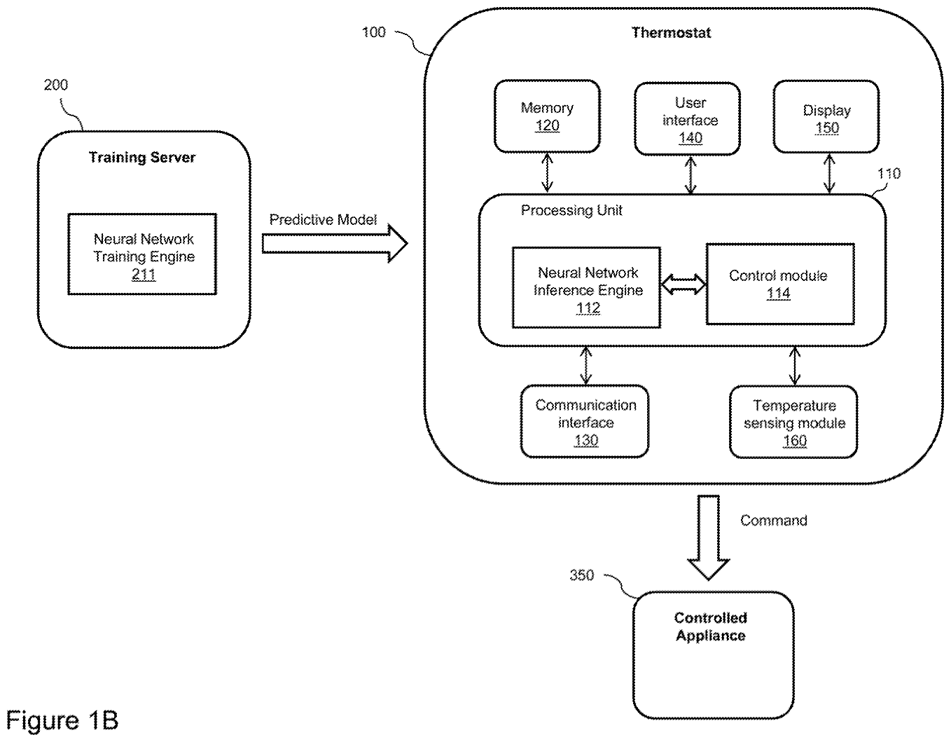

Reference is now made concurrently to FIGS. 1A and 1B, which represent an environment control system where a smart thermostat 100 is deployed. The smart thermostat 100 controls environmental conditions of an area where it is deployed. More specifically, the smart thermostat 100 controls the temperature in the area, either directly through interactions with a controlled appliance 350 (FIG. 1B) or indirectly through interactions with an environment controller 300 (FIG. 1A).

The area under the control of the smart thermostat 100 is not represented in the Figures for simplification purposes. As mentioned previously, the area may consist of a room, a floor, an aisle, etc. However, any type of area located inside any type of building is considered within the scope of the present disclosure.

Details of the smart thermostat 100, environment controller 300 and control appliance 350 will now be provided.

The smart thermostat 100 comprises a processing unit 110, memory 120, a communication interface 130, a user interface 140, a display 150, and a temperature sensing module 160. The smart thermostat 100 may comprise additional components not represented in FIGS. 1A and 1B.

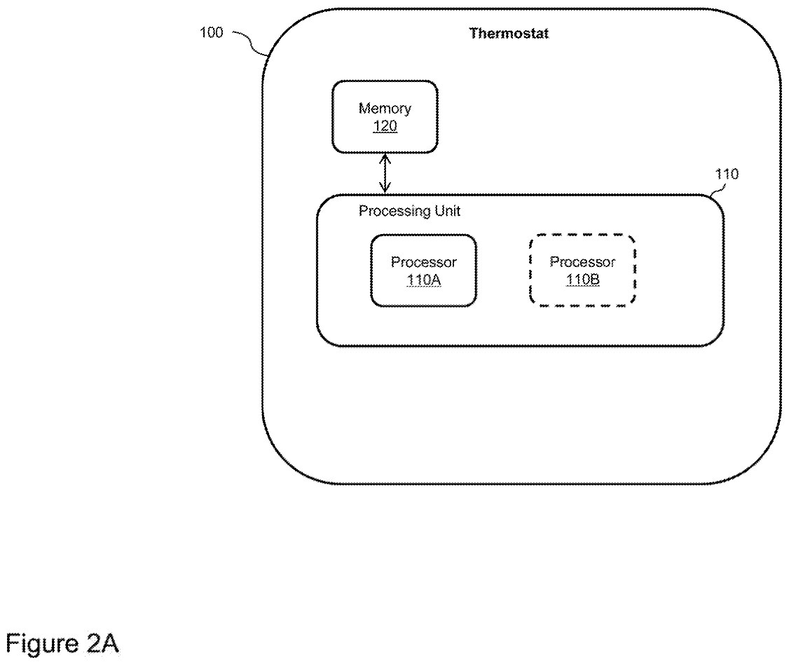

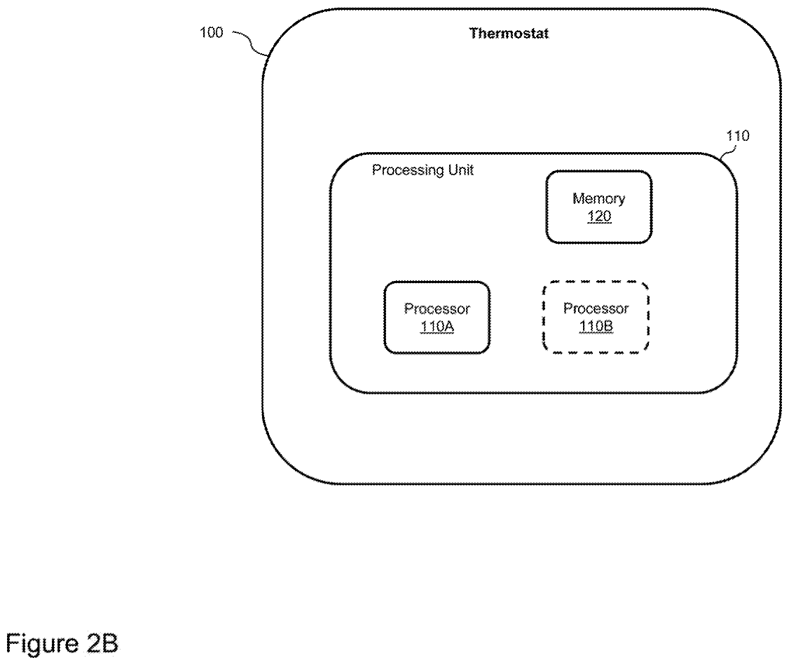

The processing unit 110 comprises one or more processor (represented in FIGS. 2A and 2B) capable of executing instructions of a computer program. Each processor may further comprise one or several cores. The processing unit 110 executes a neural network inference engine 112 and a control module 114, as will be detailed later in the description.

The memory 120 stores instructions of computer program(s) executed by the processing unit 110, data generated by the execution of the computer program(s), data received via the communication interface 130, etc. Only a single memory 120 is represented in FIGS. 1A and 1B, but the smart thermostat 100 may comprise several types of memories, including volatile memory (such as a volatile Random Access Memory (RAM), etc.) and non-volatile memory (such as an electrically-erasable programmable read-only memory (EEPROM), flash, etc.).

The communication interface 130 allows the smart thermostat 100 to exchange data with remote devices (e.g. the environment controller 300, the controlled appliance 350, a training server 200, etc.) over a communication network (not represented in FIGS. 1A and 1B for simplification purposes). For example, the communication network is a wired communication network, such as an Ethernet network; and the communication interface 130 is adapted to support communication protocols used to exchange data over the Ethernet network. Other types of wired communication networks may also be supported by the communication interface 130. In another example, the communication network is a wireless communication network, such as a Wi-Fi network; and the communication interface 130 is adapted to support communication protocols used to exchange data over the Wi-Fi network. Other types of wireless communication network may also be supported by the communication interface 130, such as a wireless mesh network, Bluetooth®, Bluetooth® Low Energy (BLE), cellular (e.g. a 4G or 5G cellular network), etc. Optionally, the smart thermostat 100 comprises more than one communication interface 130, and each one of the communication interfaces 130 is dedicated to the exchange of data with specific type(s) of device(s).

The user interface 140 may take various forms. In a first exemplary implementation, the user interface 140 is an electromechanical user interface comprising a button for raising the temperature in the area and a button for decreasing the temperature in the area. A pressure on one of the two buttons is transformed into an electrical signal transmitted to the processing unit 110. In a second exemplary implementation, the user interface 140 is a tactile user interface integrated to the display 150.

The display 150 is a small size display integrated to the thermostat, such as a Liquid Crystal Display (LCD).

The temperature sensing module 160 is a component well known in the art of environmental control. It is capable of measuring a temperature and transmitting the measured temperature to the processing unit 110. The temperature measured by the temperature sensing module 160 is considered as being representative of the temperature in the area (e.g. in the room) where the smart thermostat 100 is deployed.

As mentioned previously, FIG. 1A illustrates a configuration where the smart thermostat 100 interacts with the environment controller 300. A temperature is measured by the temperature sensing module 160 and transmitted to the environment controller 300 via the communication interface 130. A user interaction for modifying the temperature in the area is detected via the user interface 140 and a corresponding target temperature is transmitted to the environment controller 300 via the communication interface 130. The processing unit 110 generates the corresponding target temperature based on the detected user interaction. The environment controller 300 uses the measured temperature and the target temperature received from the smart thermostat 100 to control at least one controlled appliance 350. FIG. 1A represents the environment controller 300 sending a command to a controlled appliance 350 (e.g. an electrical heater, a VAV), the command being generated based on the received measured temperature and target temperature (and possibly additional parameters).

As mentioned previously, FIG. 1B illustrates a configuration where the smart thermostat 100 directly controls a controlled appliance 350 (e.g. an electrical heater, a VAV). A temperature is measured by the temperature sensing module 160. A user interaction for modifying the temperature in the area is detected via the user interface 140. A corresponding target temperature is generated by the processing unit 110 based on the detected user interaction. The processing unit uses the measured temperature and the target temperature to generate a command, which is sent to the controlled appliance 350 via the communication interface 130.

The temperature measured by the temperature sensing module 160 is also displayed on the display 150, so that a user can be informed of the current temperature (the measured temperature) in the area.

A detailed representation of the components of the environment controller 300 is not provided in FIG. 1A for simplification purposes. The environment controller 300 comprises a processing unit, memory and at least one communication interface. The processing unit of the environment controller 300 processes environmental data received from devices (e.g. from the smart thermostat 100, from sensors not represented in FIG. 1A, etc.) and generates commands for controlling appliances (e.g. 350) based on the received data. The environmental data and commands are respectively received and transmitted via the at least one communication interface.

A detailed representation of the components of the controlled appliance 350 is not provided in FIGS. 1A and 1B for simplification purposes. The controlled appliance 350 comprises at least one actuation module, to control operations of the controlled appliance 350 based on received commands. The actuation module can be of one of the following type: mechanical, pneumatic, hydraulic, electrical, electronical, a combination thereof, etc. The controlled appliance 350 further comprises a communication interface for receiving the commands from the environment controller 300 (FIG. 1A) or from the smart thermostat 100 (FIG. 1B). The controlled appliance 350 may also comprise a processing unit for controlling the operations of the at least one actuation module based on the received one or more command.

An example of a controlled appliance 350 consists of a VAV appliance. Examples of commands transmitted to the VAV appliance include commands directed to one of the following: an actuation module controlling the speed of a fan, an actuation module controlling the pressure generated by a compressor, an actuation module controlling a valve defining the rate of an airflow, etc. This example is for illustration purposes only. Other types of controlled appliances 350 could be used in the context of interactions with the environment controller 300 or with the smart thermostat 100.

A detailed representation of the components of the training server 200 is not provided in FIGS. 1A and 1B for simplification purposes. The training server 200 comprises a processing unit, memory and a communication interface. The processing unit of the training server 200 executes a neural network training engine 211. The execution of the neural network training engine 211 generates a predictive model, which is transmitted to the smart thermostat 100 via the communication interface of the training server 200. The predictive model is transmitted over a communication network and received via the communication interface 130 of the smart thermostat 100.

Reference is now made concurrently to FIGS. 1A, 1B, 2A and 2B. As mentioned previously, the processing unit 110 may include one or more processor. For example, the processing unit 110 includes a single processor 110A, which executes the neural network inference engine 112 and the control module 114. In another example, the processing unit 110 includes a first processor 110A which executes the neural network inference engine 112 and a second processor 110B which executes the control module 114. Furthermore, FIG. 2A illustrates a configuration where the memory 120 is not integrated to the processing unit 110, while FIG. 2B illustrates a configuration where the memory 120 is integrated to the processing unit 110.

The term processor shall be interpreted broadly as including any electronic component capable of executing instructions of a software program stored in the memory 120.

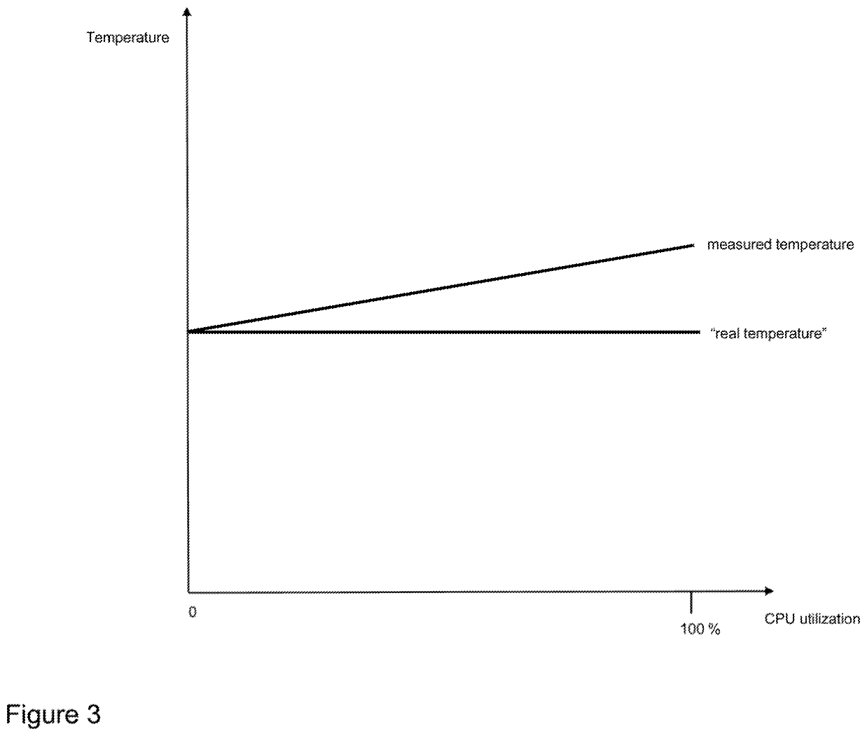

Reference is now made concurrently to FIGS. 1A, 1B, 2A, 2B and 3. FIG. 3 represents a curve illustrating the influence of Central Processing Unit (CPU) utilization on the temperature measured by the temperature sensing module 160. CPU utilization is a terminology well known in the art of computing, and represents the utilization (expressed in percentage) of a processor (e.g. 110A) of the processing unit 110. Heat dissipated by the processor (e.g. 110A) increases with CPU utilization. FIG. 3 represents the “real temperature” in the area where the smart thermostat 100 is deployed, and the temperature measured by the temperature sensing module 160. At low CPU utilization, the measured temperature is a good approximation of the real temperature in the area. However, as CPU utilization increases, the measured temperature is no longer a good approximation of the real temperature in the area. For simplification purposes, the measured temperature increases linearly with the CPU utilization. However, the relationship between the measured temperature and the CPU utilization is a more complex one, which is out of the scope of the present disclosure.

A similar curve may be represented, illustrating the influence of the utilization of the display 150 on the temperature measured by the temperature sensing module 160. An increase in the utilization of the display 150 generates more heat, which increases the deviation of the measured temperature from the real temperature.

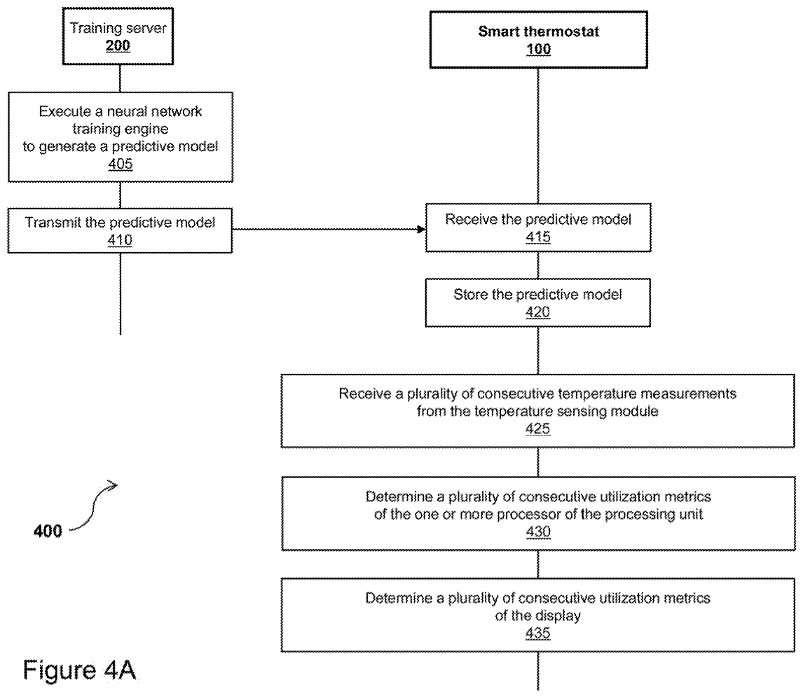

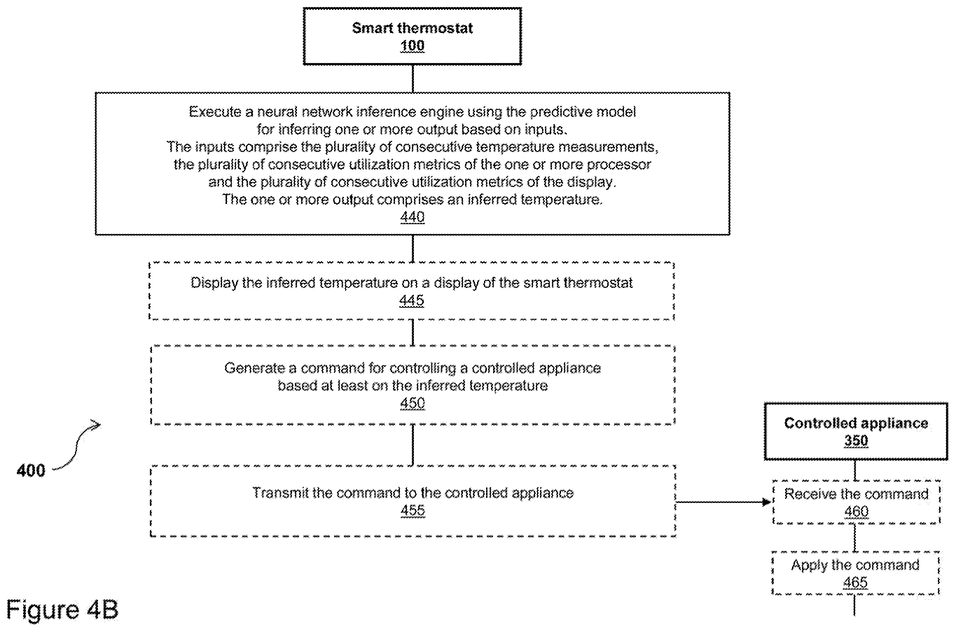

Reference is now made concurrently to FIGS. 1A, 1B, 2A, 2B, 4A and 4B. FIGS. 4A and 4B illustrate a method 400 using a neural network to adjust temperature measurements. At least some of the steps of the method 400 are implemented by the smart thermostat 100. However, the present disclosure is not limited to the smart thermostat 100, but is applicable to any type of computing device capable of implementing the steps of the method 400.

A dedicated computer program has instructions for implementing at least some of the steps of the method 400. The instructions are comprised in a non-transitory computer program product (e.g. the memory 120) of the smart thermostat 100. The instructions provide for using a neural network to adjust temperature measurements, when executed by the processing unit 110 of the smart thermostat 100. The instructions are deliverable to the smart thermostat 100 via an electronically-readable media such as a storage media (e.g. USB key, etc.), or via communication links (e.g. via a communication network through the communication interface 130).

The instructions of the dedicated computer program executed by the processing unit 110 implement the neural network inference engine 112 and the control module 114. The neural network inference engine 112 provides functionalities of a neural network, allowing to infer output(s) based on inputs using the predictive model stored in the memory 120, as is well known in the art. The control module 114 provides functionalities for controlling the components of the smart thermostat 100 and for allowing the smart thermostat 100 to interact with and/or control other devices (e.g. the environment controller 300 or the controlled appliance 350).

The method 400 comprises the step 405 of executing the neural network training engine 211 to generate the predictive model. Step 405 is performed by the processing unit of the training server 200. This step will be further detailed later in the description.

The method 400 comprises the step 410 of transmitting the predictive model generated at step 405 to the smart thermostat 100, via the communication interface of the training server 200. Step 410 is performed by the processing unit of the training server 200.

The method 400 comprises the step 415 of receiving the predictive model from the training server 200, via the communication interface 130 of the smart thermostat 100. Step 415 is performed by the processing unit 110 of the smart thermostat 100.

The method 400 comprises the step 420 of storing the predictive model in the memory 120 of the smart thermostat 100. Step 420 is performed by the processing unit 110 of the smart thermostat 100.

The method 400 comprises the step 425 of receiving a plurality of consecutive temperature measurements from the temperature sensing module 160. Step 425 is performed by the control module 114 executed by the processing unit 110. As mentioned previously, the measurement of a temperature by a temperature sensing module (e.g. 160) is well known in the art.

The method 400 comprises the step 430 of determining a plurality of consecutive utilization metrics of the one or more processor (e.g. only processor 110A as illustrated in FIG. 2A, or processors 110A and 110B as illustrated in FIG. 2B) of the processing unit 110. Step 430 is performed by the control module 114 executed by the processing unit 110.

As mentioned previously, a commonly used utilization metric of a processor is the CPU utilization of the processor, which can be represented as a percentage varying from 0 to 100%. In the case of a single processor 110A, the utilization metric for the processing unit 110 is the CPU utilization of the processor 110A. In the case of several processors (e.g. 110A and 110B), the utilization metric for the processing unit 110 is calculated based on the CPU utilizations of each one of the several processors. Following is a first exemplary implementation in the case of the two processors 110A and 110B. The utilization metric for the processing unit 110 is the average of the CPU utilization of the processor 110A and the CPU utilization of the processor 110B. For example, the CPU utilization of the processor 110A is 20% and the CPU utilization of the processor 110B is 80%, and the utilization metric for the processing unit 110 is (20%+80%)/2=50%. Following is a second exemplary implementation in the case of the two processors 110A and 110B. The utilization metric for the processing unit 110 is a weighted average of the CPU utilization of the processor 110A and the CPU utilization of the processor 110B. For example, the CPU utilization of the processor 110A is 20% with a weight of 1 and the CPU utilization of the processor 1106 is 80% with a weight of 2, and the utilization metric for the processing unit 110 is (20%*1+80%*2)/3=60%. The utilization of a weighted average allows to take into account the specific individual contributions of the processors to the heating of the smart thermostat 100 (a more powerful processor contributes more than a less powerful processor to the heating for the same value of the CPU utilization).

A person skilled in the art would readily understand that the utilization metric of processor(s) of the processing unit 110 may be calculated in a different way, as long as the utilization metric is representative of the contribution of the processor(s) of the processing unit 110 to the heating of the smart thermostat 100.

The method 400 comprises the step 435 of determining a plurality of consecutive utilization metrics of the display 150. Step 435 is performed by the control module 114 executed by the processing unit 110.

An exemplary utilization metric of the display 150 is a percentage of utilization of the display varying from 0 to 100%, and representative of a dimming level or light intensity output of the display 150. For example, the percentage of utilization is based on a pulse-width-modulation (PWM) voltage used for controlling the dimming level or light intensity output of the display 150. If the current PWM voltage is V and the maximum PWM voltage is Vₘₐₓ then the utilization metric of the display 150 is V/Vₘₐₓ*100%.

Another exemplary utilization metric of the display 150 is a measurement of the illumination in the area expressed in lux. In this case, the smart thermostat 100 includes an illumination sensor (not represented in the Figures for simplification purposes) capable of measuring the illumination in the area. The illumination sensor is used to adjust the backlight of the display 150. The backlight is decreased (producing less heat) if the measured illumination decreases and the backlight is increased (producing more heat) if the measured illumination increases (above a certain level of measured illumination, the backlight is always set to 100%).

A person skilled in the art would readily understand that the utilization metric of the display 150 may be calculated in a different way, as long as the utilization metric is representative of the contribution of the display 150 to the heating of the smart thermostat 100.

The method 400 comprises the step 440 of executing the neural network inference engine 112 using the predictive model (stored at step 420) for inferring one or more output based on inputs. The inputs comprise the plurality of consecutive temperature measurements (received at step 425), the plurality of consecutive utilization metrics of the one or more processor of the processing unit (determined at step 430) and the plurality of consecutive utilization metrics of the display 150 (determined at step 435). The one or more output comprises an inferred temperature Step 440 is performed by the neural network inference engine 112 executed by the processing unit 110.

The method 400 aims at generating an inferred temperature that is a more accurate evaluation of the “real” temperature in the area than a non-adjusted temperature measurement performed by the temperature sensing module 160.

The inputs used by the neural network inference engine 112 may include other parameter(s). Similarly, the one or more output generated by the neural network inference engine 112 may include other inferred data.

For instance, the method 400 comprises the additional step (similar to steps 430 and 435, and not represented in FIG. 4A for simplification purposes) of determining a plurality of consecutive utilization metrics of at least one other component of the smart thermostat 100. The at least one other component has a significant contribution to the heating of the smart thermostat 100. The plurality of consecutive utilization metrics of the at least one other component of the smart thermostat 100 is used as inputs of the neural network inference engine 112 at step 440 (in addition to the utilization metrics of the processor(s) and display).

For example, the at least one other component of the smart thermostat 100 is the communication interface 130. The utilization metric may be calculated based on the transmission rate and/or reception rate of the communication interface 130 (e.g. percentage of utilization of the communication interface 130 for transmitting and/or receiving data expressed as a percentage of the maximum available capacity).

Alternatively, the method 400 may be applied to a device having no display, or having a display with a marginal contribution to the heating of the device. In this case, step 430 of the method 400 is not performed and the plurality of consecutive utilization metrics of a display of the device is not used as inputs of the neural network inference engine 112 at step 440

The following steps 445 to 465 are for illustration purposes only, and illustrate the usage of the temperature inferred at step 440. In particular, steps 450 to 465 illustrate the use case represented in FIG. 1B.

The method 400 comprises the step 445 of displaying the temperature inferred at step 440 on the display 150. Step 445 is performed by the control module 114 executed by the processing unit 110.

The method 400 comprises the step 450 of generating a command for controlling the controlled appliance 350. The command is based at least on the temperature inferred at step 440. Step 450 is performed by the control module 114 executed by the processing unit 110. For example, the command uses the inferred temperature and a target temperature (received from a user via the user interface 140) to generate a command for controlling an electrical heater or a VAV appliance.

The method 400 comprises the step 455 of transmitting the command (generated at step 450) to the controlled appliance 350 via the communication interface 130. Step 455 is performed by the control module 114 executed by the processing unit 110.

The method 400 comprises the step 460 of receiving the command at the controlled appliance 350, via the communication interface of the controlled appliance 350. Step 460 is performed by the processing unit of the controlled appliance 350.

The method 400 comprises the step 465 of applying the command at the controlled appliance 350. Step 465 is performed by the processing unit of the controlled appliance 350. Applying the command consists in controlling one or more actuation module of the controlled appliance 350 based on the received command.

In a particular implementation, the temperature sensing module 160 is also capable of measuring a humidity level in the area (where the smart thermostat 100 is deployed), and transmitting the measured humidity level to the processing unit 110. The measured humidity level is also influenced by heat generated by components (e.g. processing unit 110, display 150, etc.) of the smart thermostat 100. Thus, after step 440, the measured humidity level is adjusted by the processing unit 110 based on the inferred temperature determined at step 430. This optional step is not represented in FIG. 4B for simplification purposes. Various algorithms may be used for adjusting the measured humidity level based on the inferred temperature.

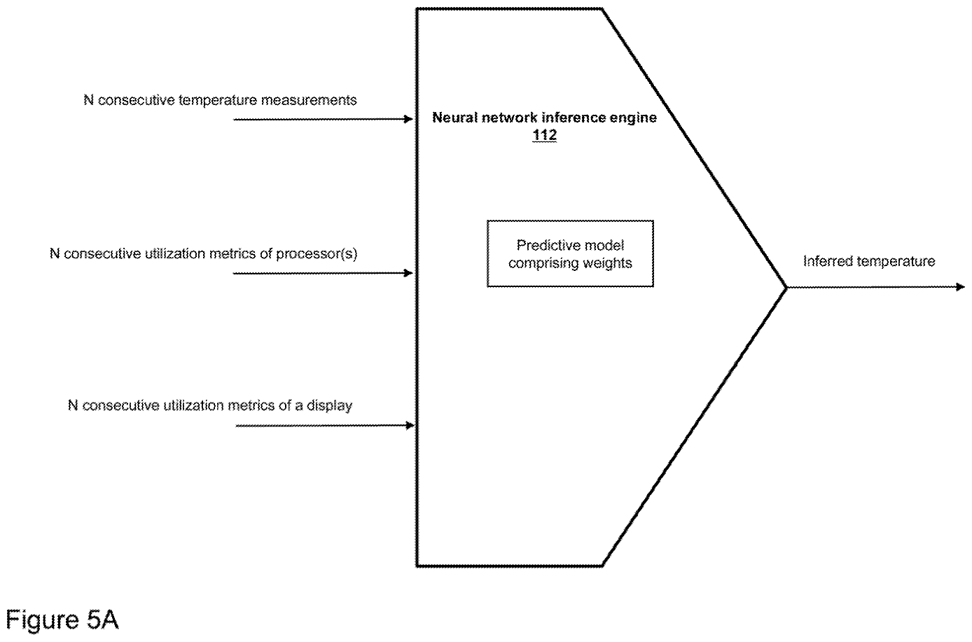

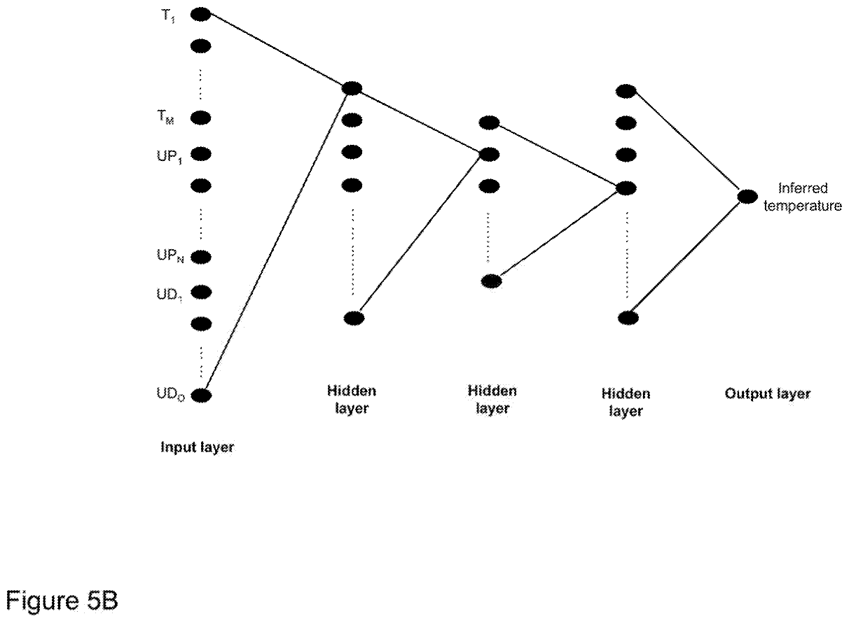

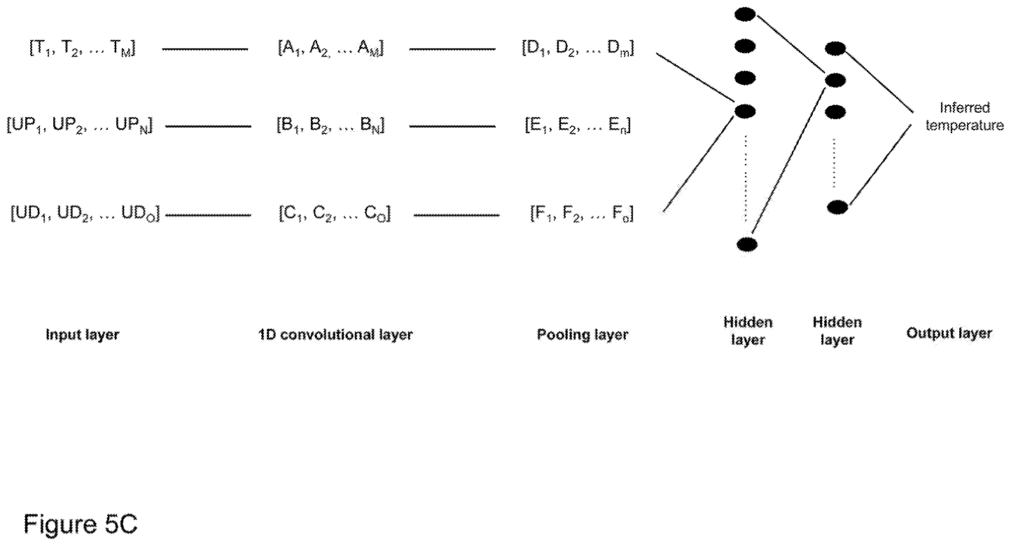

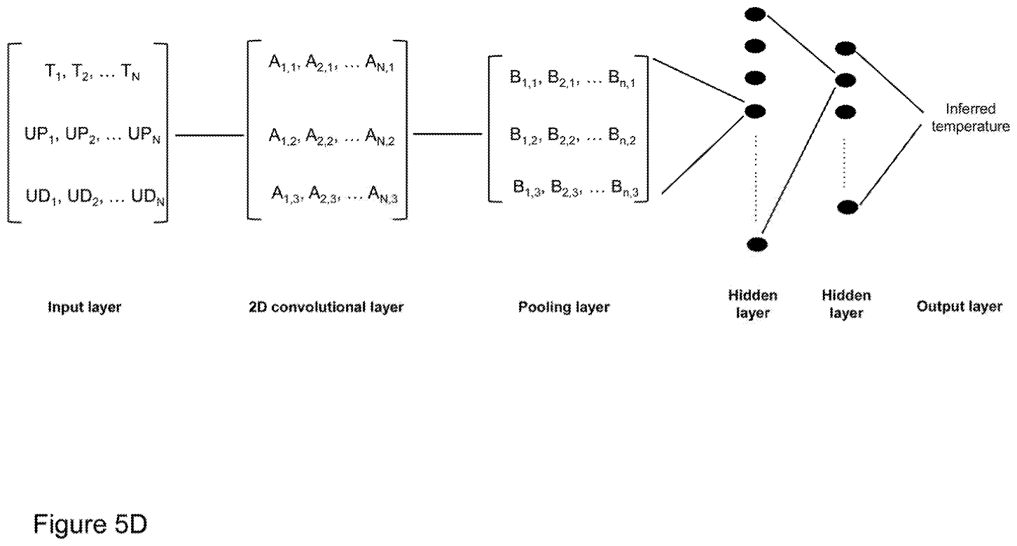

Reference is now made concurrently to FIGS. 4B, 5A, 5B, 5C and 5D. FIG. 5A illustrates the inputs and the outputs used by the neural network inference engine 112 when performing step 440. The inputs include N consecutive temperature measurements, N consecutive utilization metrics of the processor(s) and N consecutive utilization metrics of the display; where N is an integer (for example, N=10). However, the number of consecutive values used as inputs may be different for the temperature measurements (e.g. 5), the utilization metrics of the processor(s) (e.g. 10) and the utilization metrics of the display (e.g. 5).

For illustration purposes, we consider a set of M consecutive temperature measurements T₁, T₂ . . . T_{M}. We consider a set of N consecutive utilization metrics of the processor(s) UP₁, UP₂ . . . UP_{N}. We consider a set of O consecutive utilization metrics of the display UD₁, UD₂ . . . UD_{O}. As mentioned previously, M, N and O are integers of the same or different values.

In a first implementation illustrated in FIG. 5B, the neural network inference engine 112 implements a neural network comprising an input layer, followed by one or more intermediate hidden layer, followed by an output layer; where the hidden layers are fully connected. The input layer comprises at least M+N+O neurons. The first M input neurons receive the M consecutive temperature measurements T₁, T₂ . . . T_{M}. The next N input neurons receive the N consecutive utilization metrics of the processor(s) UP₁, UP₂ . . . UP_{N}. The next O input neurons receive the O consecutive utilization metrics of the display UD₁, UD₂ . . . UD_{O}. The output layer comprises at least one neuron outputting the inferred temperature.

A layer L being fully connected means that each neuron of layer L receives inputs from every neurons of layer L−1, and applies respective weights to the received inputs. By default, the output layer is fully connected the last hidden layer.

The generation of the outputs based on the inputs using weights allocated to the neurons of the neural network is well known in the art for a neural network using only fully connected hidden layers. The architecture of the neural network, where each neuron of a layer (except for the first layer) is connected to all the neurons of the previous layer is also well known in the art.

In a second implementation represented in FIG. 5C, the neural network inference engine 112 implements a one dimensional (1D) convolutional neural network comprising an input layer, followed by one or more 1D convolutional layer, followed by one or more intermediate hidden layer, followed by an output layer. Optionally, each 1D convolutional layer is followed by a pooling layer.

The input layer comprises at least 3 neurons. The first neuron of the input layer receives a first one-dimension matrix of consecutive temperature measurements Tᵢ, with i varying from 1 to M. The second neuron of the input layer receives a second one-dimension matrix of consecutive utilization metrics of the processor(s) UPⱼ, with j varying from 1 to N. The third neuron of the input layer receives a third one-dimension matrix of consecutive utilization metrics of the display UDₖ, with k varying from 1 to 0. The M, N and O integers may have the same or different values.

The first layer following the input layer is the 1D convolutional layer applying three respective 1D convolutions to the three matrixes. The first 1D convolution uses a one dimension filter of size lower than M. The second 1D convolution uses a one dimension filter of size lower than N. The third 1D convolution uses a one dimension filter of size lower than 0.

The output of the 1D convolutional layer consists in three respective resulting matrixes [A₁, A₂, . . . A_{M}], [B₁, B₂, . . . B_{N}] and [C₁, C₂, . . . C_{O}]. As mentioned previously, the 1D convolutional layer may be followed by a pooling layer for reducing the size of the three resulting matrixes into respective reduced matrixes [D₁, D₂, . . . Dₘ], [E₁, E₂, . . . Eₙ] and [F₁, F₂, . . . Fₒ], where m is lower than M, n is lower than N and o is lower than O. Various algorithms (e.g. maximum value, minimum value, average value, etc.) can be used for implementing the pooling layer, as is well known in the art (a one dimension filter of given size is also used by the pooling layer).

The neural network may include several consecutive 1D convolutional layers, optionally respectively followed by pooling layers. The three input matrixes [T₁, T₂, . . . T_{M}], [UP₁, UP₂, . . . UP_{N}] and [UD₁, UD₂, . . . UD_{O}] are processed independently from one another along the chain of 1D convolutional layer(s) and optional pooling layer(s).

The chain of 1D convolutional layer(s) and optional pooling layer(s) is followed by the one or more fully connected hidden layer, which operates with weights associated to neurons, as is well known in the art.

In a third implementation represented in FIG. 5D, the neural network inference engine 112 implements a two dimensional (2D) convolutional neural network comprising an input layer, followed by one or more 2D convolutional layer, followed by one or more intermediate hidden layer, followed by an output layer.

Optionally, each 2D convolutional layer is followed by a pooling layer. The number of consecutive values N for the measured temperatures, the utilization metrics of the processor(s) and the utilization metrics of the display is the same.

The input layer comprises at least one neuron receiving a two-dimensions (N×3) matrix with the consecutive values of the measured temperatures, the utilization metrics of the processor(s) and the utilization metrics of the display. Following is a representation of the input matrix:

[T₁, T₂, . . . T_{N},
UP₁, IP₂, . . . UP_{N},
UD₁, UD₂, . . . UD_{N}]

The first layer following the input layer is the 2D convolutional layer applying a 2D convolution to the N×3 input matrix. The 2D convolution uses a two-dimensions filter of size S×T, where S is lower than N and T is lower than 3. The output of the 2D convolutional layer consists in a resulting matrix:

[A_{1,1}, A_{2,1}, . . . A_{N,1},
A_{1,2}, A_{2,2}, . . . A_{N,2},
A_{1,3}, A_{2,3}, . . . A_{N,3}]

As mentioned previously, the 2D convolutional layer may be followed by a pooling layer for reducing the size of the resulting matrix into a reduced matrix:

[B_{1,1}, B_{2,1}, . . . B_{n,1},
B_{1,2}, B_{2,2}, . . . B_{n,2},
B_{1,3}, B_{2,3}, . . . B_{n,3}]
where n is lower than N. Various algorithms can be used for implementing the pooling layer, as is well known in the art (a two-dimensions filter of given size is also used by the pooling layer).

The neural network may include several consecutive 2D convolutional layers, optionally respectively followed by pooling layers.

The chain of 2D convolutional layer(s) and optional pooling layer(s) is followed by the one or more fully connected hidden layer, which operate with weights associated to neurons, as is well known in the art.

The usage of one or more 1D convolutional layer (second implementation) allows to detect patterns between the values of the measured temperatures, independently of patterns between the values of the utilization metrics of the processor(s), and independently of patterns between the values of the utilization metrics of the display.

The usage of one or more 2D convolutional layer (third implementation) allows to detect patterns between the values of the measured temperatures, the values of the utilization metrics of the processor(s) and the values of the utilization metrics of the display in combination.

The usage of additional inputs at step 440 (e.g. the plurality of consecutive utilization metrics of the communication interface 130) may improve the accuracy and resiliency of the inferences performed by the neural network inference engine 112 (at the cost of complexifying the predictive models used by the neural network inference engine 112). The relevance of using particular additional inputs is generally evaluated during the training phase, when the predictive model is generated (and tested) with a set of training (and testing) inputs and outputs dedicated to the training (and testing) phase.

When using a 2D convolutional layer, the inputs of the neural network usually need to be normalized before processing by the convolutional layer. Normalization consists in adapting the input data (temperature, utilization metric of the processor, utilization metric of the display, etc.), so that all input data have the same reference. The input data can then be compared one to the others. Normalization may be implemented in different ways, such as: bringing all input data between 0 and 1, bringing all input data around the mean of each feature (for each input data, subtract the mean and divide by the standard deviation on each feature individually), etc. The effect of normalization is smoothing the image for the 2D convolution and preventing to always take the same feature at the pooling step.

Referring back to FIGS. 1A, 1B and 4A, the training phase performed by the neural network training engine 211 of the training server 200 (when performing step 405 of the method 400) is well known in the art. The inputs and output(s) of the neural network training engine 211 are the same as those previously described for the neural network inference engine 112. The training phase consists in generating the predictive model that is used during the operational phase by the neural network inference engine 112. The predictive model includes the number of layers, the number of neurons per layer, and the weights associated to the neurons of the fully connected hidden layers. The values of the weights are automatically adjusted during the training phase. Furthermore, during the training phase, the number of layers and the number of neurons per layer can be adjusted to improve the accuracy of the model.

Various techniques well known in the art of neural networks are used for performing (and improving) the generation of the predictive model, such as forward and backward propagation, usage of bias in addition to the weights (bias and weights are generally collectively referred to as weights in the neural network terminology), reinforcement training, etc.

In the case where a convolutional layer is used, parameters of the convolutional layer are also defined and optionally adapted during the training phase. For example, the size of the filter used for the convolution is determined during the training period. The parameters of the convolutional layer are included in the predictive model.

Similarly, in the case where a pooling layer is used, parameters of the pooling layer are also defined and optionally adapted during the training phase. For example, the algorithm and the size of the filter used for the pooling operation are determined during the training period. The parameters of the polling layer are included in the predictive model.

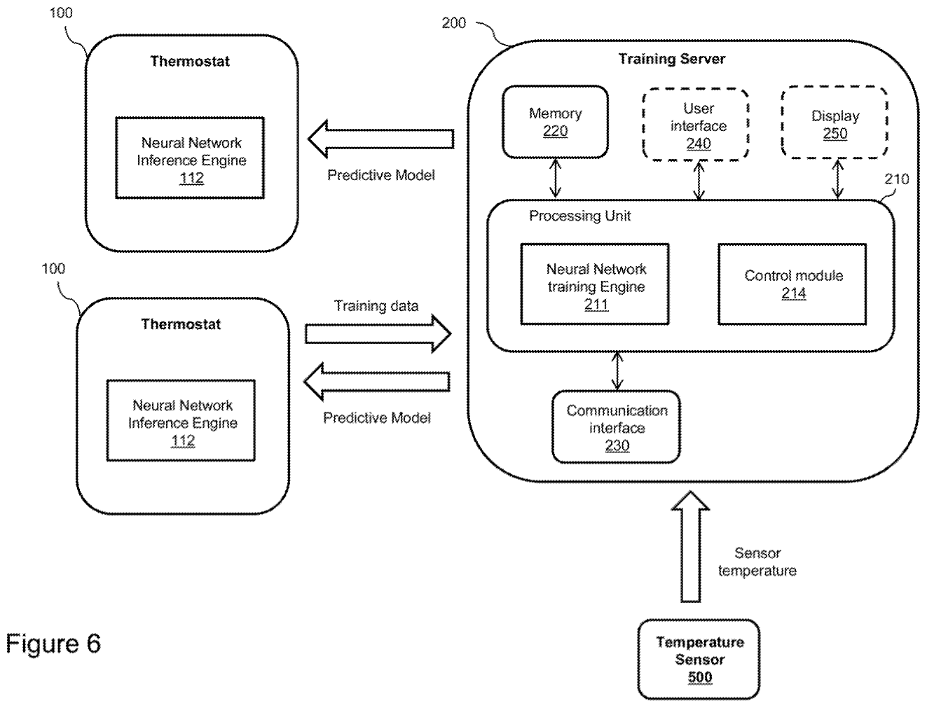

Reference is now made concurrently to FIGS. 1A, 1B, 4A, 4B and 6, where FIG. 6 illustrates the usage of the method 400 in an environment control system comprising several smart thermostats 100.

A plurality of smart thermostats 100 implementing the method 400 are deployed at different locations. Only two smart thermostats 100 are represented in FIG. 6 for illustration purposes, but any number of smart thermostats 100 may be deployed. The different locations may consist of different areas in a given building (e.g. different rooms of the given building on the same of different floors of the given building). The different locations may also be spread across several different buildings.

Each smart thermostat 100 represented in FIG. 6 corresponds to the smart thermostat 100 represented in FIGS. 1A and 1B, and executes both the control module 114 and the neural network inference engine 112. Each smart thermostat 100 receives a predictive model from the centralized training server 200 (e.g. a cloud based training server 200 in communication with the smart thermostats 100 via a networking infrastructure, as is well known in the art). The same predictive model is used for all the smart thermostats 100. Alternatively, a plurality of predictive models is generated, and takes into account specific characteristics of the smart thermostats 100. For example, a first predictive model is generated for smart thermostats 100 having a first type of processing unit 100 dissipating a small amount of heat (via the processor(s) of the processing unit 100). A second predictive model is generated for smart thermostats 100 having a second type of processing unit 100 dissipating a larger amount of heat (via the processor(s) of the processing unit 100).

Furthermore, at least some of the smart thermostats 100 are adapted to transmitting training data to the training server 200. These training data are used in combination with sensor temperature measurements transmitted by temperature sensor(s) 500 for generating the predictive model during the training phase of the neural network. For each smart thermostat 100 transmitting training data, a corresponding temperature sensor 500 is deployed in the same area as the smart thermostat 100 for measuring the “real” temperature in the area (by contrast to the temperature measured by the temperature sensing module 160 of the smart thermostat 100 which is not accurate as previously described).

Details of the components of the training server 200 are also represented in FIG. 6. The training server 200 comprises a processing unit 210, memory 220, and a communication interface 230. The training server 200 may comprise additional components, such as another communication interface 230, a user interface 240, a display 250, etc.

The characteristics of the processing unit 210 of the training server 200 are similar to the previously described characteristics of the processing unit 110 of the smart thermostat 100. The processing unit 210 executes the neural network training engine 211 and a control module 214.

The characteristics of the memory 220 of the training server 200 are similar to the previously described characteristics of the memory 120 of the smart thermostat 100.

The characteristics of the communication interface 230 of the training server 200 are similar to the previously described characteristics of the communication interface 130 of the smart thermostat 100.

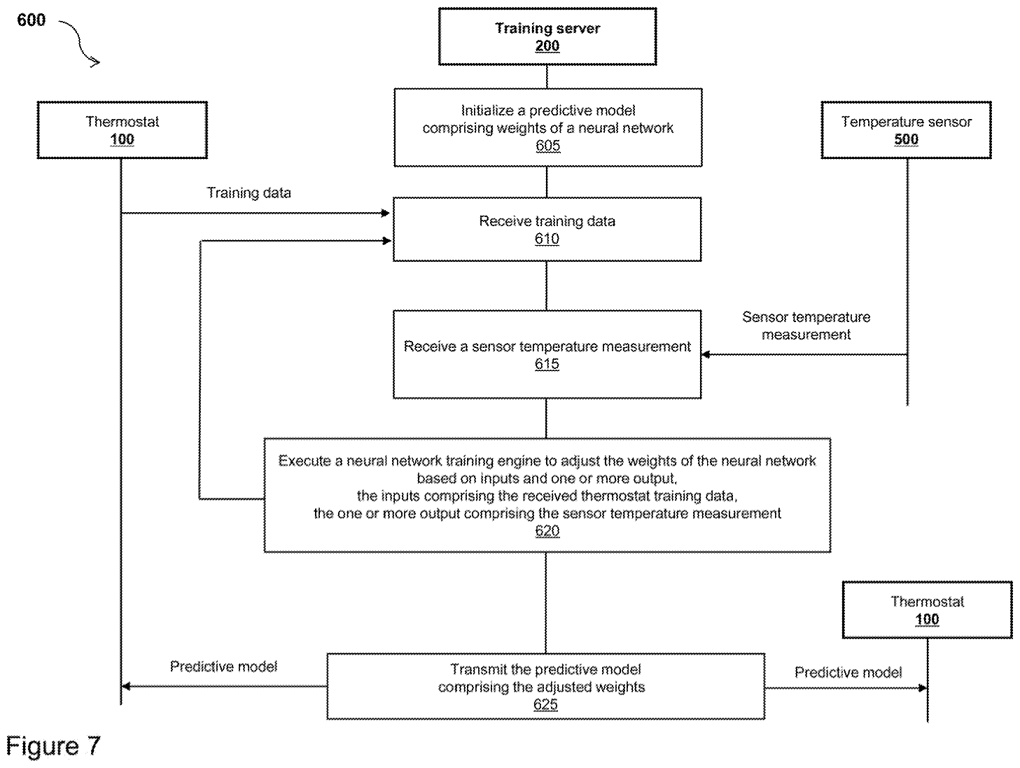

Reference is now made concurrently to FIGS. 1A, 1B, 4A-4B, 6 and 7. FIG. 7 represents a method 600 for training a neural network to adjust temperature measurements. At least some of the steps of the method 600 represented in FIG. 7 are implemented by the training server 200. The present disclosure is not limited to the method 600 being implemented by the training server 200, but is applicable to any type of computing device capable of implementing the steps of the method 600.

A dedicated computer program has instructions for implementing at least some of the steps of the method 600. The instructions are comprised in a non-transitory computer program product (e.g. the memory 220) of the training server 200. The instructions provide for training a neural network to adjust temperature measurements, when executed by the processing unit 210 of the training server 200. The instructions are deliverable to the training server 200 via an electronically-readable media such as a storage media (e.g. CD-ROM, USB key, etc.), or via communication links (e.g. via a communication network through the communication interface 230).

The instructions of the dedicated computer program executed by the processing unit 210 implement the neural network training engine 211 and the control module 214. The neural network training engine 211 provides functionalities for training a neural network, allowing to generate a predictive model (more specifically to optimize weights of the neural network), as is well known in the art. The control module 214 provides functionalities allowing the training server 200 to gather data used for the training of the neural network.

An initial predictive model is generated by the processing unit 210 of the training server 200. Alternatively, the initial predictive model is generated by and received from another computing device (not represented in the Figures for simplification purposes) via the communication interface 230 of the training server 200.

The generation of the initial predictive model is out of the scope of the present disclosure. Generating the initial predictive model comprises defining a number of layers of the neural network, a number of neurons per layer, the initial value for the weights of the neural network, etc.

The definition of the number of layers and the number of neurons per layer is performed by a person highly skilled in the art of neural networks. Different algorithms (well documented in the art) can be used for allocating an initial value to the weights of the neural network. For example, each weight is allocated a random value within a given interval (e.g. a real number between −0.5 and +0.5), which can be adjusted if the random value is too close to a minimum value (e.g. −0.5) or too close to a maximum value (e.g. +0.5).

The execution of the method 600 by the training server 200 provides for generating an operational predictive model (by adjusting the weights of the predictive model). At the end of the training phase, the operational predictive model is ready to be used by the neural network inference engines 112 of the smart thermostats 100. Optionally, the operational predictive model can be used as a new initial predictive model, which can be further improved by implementing the aforementioned procedure again.

The method 600 comprises the step 605 of initializing the predictive model. Step 605 is performed by the control module 214 executed by the processing unit 210. The initial predictive model comprises initial values of the weights of the neural network implemented by the neural network training engine 211. As mentioned previously, the initialization of the predictive model is either entirely (or at least partially) performed by the control module 214, or simply consists in receiving an initial predictive model (via the communication interface 230) generated by another computing device.

The method 600 comprises the step 610 of receiving training data from a given smart thermostat 100 via the communication interface 230. Step 610 is performed by the control module 214 executed by the processing unit 210.

The training data include a plurality of consecutive temperature measurements performed by the temperature sensing module 160 of the given smart thermostat 100. The training data also include a plurality of consecutive utilization metrics of the one or more processor (e.g. 110A only in FIG. 2A, 110A and 110B in FIG. 2B) of the processing unit 110 of the given smart thermostat 100. The training data further include a plurality of consecutive utilization metrics of the display 150 of the of the given smart thermostat 100. The measurement and collection of the temperature measurements, utilization metrics of the one or more processor and utilization metrics of the display in the presently described training phase is similar to the measurements previously described for the operational phase implemented by the method 400.

The method 600 comprises the step 615 of receiving a sensor temperature measurement from the temperature sensor 500 via the communication interface 230. Step 615 is performed by the control module 214 executed by the processing unit 210.

A detailed representation of the components of the temperature sensor 500 is not provided in FIG. 6, since a temperature sensor is well known in the art. The temperature sensor 500 comprises a temperature sensing module for measuring the temperature in the area where it is deployed, and a communication interface for transmitting the measured temperature to the training server 200.

The temperature sensor 500 and the given smart thermostat 100 mentioned in step 610 are located in the same area. Thus, the respective temperature sensing modules of the temperature sensor 500 and the given smart thermostat 100 both measure the temperature in the same area.

The method 600 comprises the step 620 of executing the neural network training engine 211 to adjust the weights of the neural network based on inputs and one or more output. The inputs comprise the thermostat training data received at step 610. The one or more output comprises the sensor temperature measurement received at step 615. Step 620 is performed by the processing unit 210. Step 620 corresponds to step 405 of the method 400.

The neural network training engine 211 implements the neural network using the weights of the predictive model initialized at step 605. The neural network implemented by the neural network training engine 211 corresponds to the neural network implemented by the neural network inference engine 112 (same number of layers, same number of neurons per layer, etc.). As mentioned previously, FIGS. 5B, 5C and 5D illustrate different detailed exemplary implementations of such a neural network.

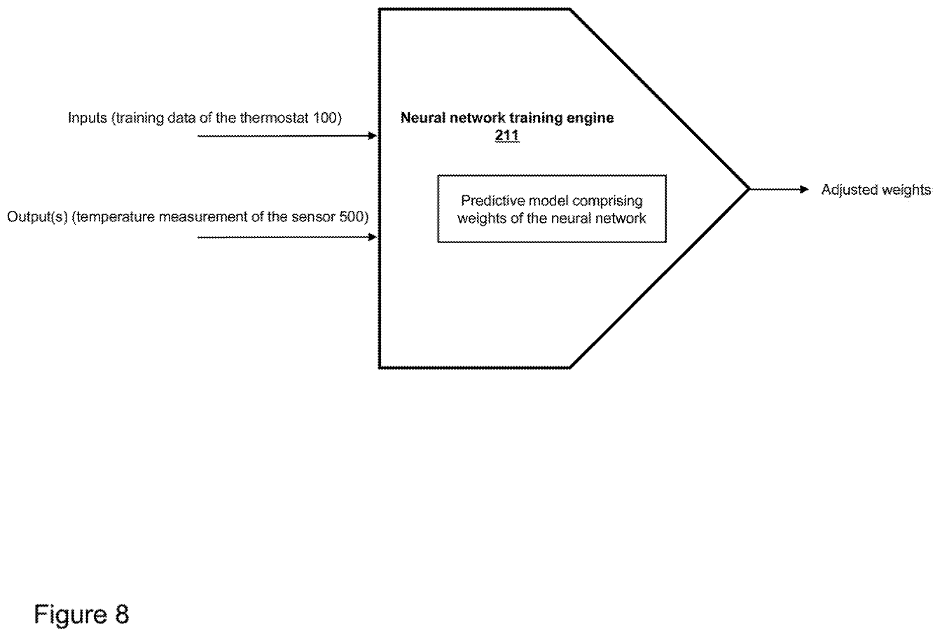

FIG. 8 is a schematic representation of the neural network training engine 211 illustrating the inputs and the one or more output used by the neural network inference engine 211 when performing step 620.

The adjusted weights are stored in the memory 220 of the training server 200, and steps 610-615-620 are repeated a plurality of times. At each iteration of steps 610-615-620, the weights adjusted by the previous iteration are used by the neural network training engine 211 at step 620 to be further adjusted.

The execution of steps 610-615-620 is implementation dependent. In a first exemplary implementation, as soon as the training server 200 receives the training data at step 610 and the sensor temperature measurement at step 615, step 620 is immediately performed. In a second exemplary implementation, the training server 200 waits for the reception of a substantial amount of training data (step 610) and corresponding sensor temperature measurements (step 615), before performing step 620. In this second implementation, the received training data and corresponding sensor temperature measurements are stored in the memory 220 before being used. Furthermore, some of the received data may be discarded by the training server 200 (e.g. a set of data is redundant with another already received set of data, at least some of the received data are considered erroneous or non-usable, etc.).

At the end of the training phase implemented by the repetition of steps 610-615-620, the neural network is considered to be properly trained. An operational predictive model comprising an operational version of the weights is transmitted to the given smart thermostat 100, which was used for the training phase. The operational predictive model may also be transmitted to one or more additional smart thermostat 100, which was not involved in the training phase (as illustrated in FIGS. 6 and 7). Optionally, the operational predictive model is not transmitted to the given smart thermostat 100, which was used for the training phase, because this given smart thermostat 100 is not used during the operational phase. Various criteria may be used to determine when the neural network is considered to be properly trained, as is well known in the art of neural networks. This determination and the associated criteria is out of the scope of the present disclosure.

The method 600 comprises the step 625 of transmitting the predictive model comprising the adjusted weights to one or more smart thermostat 100 via the communication interface 230. Step 625 is performed by the control module 214 executed by the processing unit 210. Step 625 corresponds to step 410 of the method 400. From this point on, the one or more smart thermostat 100 (which receive the predictive model) enter an operational mode, where the predictive model is used at step 440 of the method 400.

Additionally, during the training phase, the number of intermediate hidden layers of the neural network and the number of neurons per intermediate hidden layer can be adjusted to improve the accuracy of the predictive model. At the end of the training phase, the predictive model generated by the neural network training engine 211 includes the number of layers, the number of neurons per layer, and the weights.

As mentioned previously, in the case where a convolutional layer is used, parameters of the convolutional layer are also defined and optionally adapted during the training phase, and further included in the predictive model transmitted at step 625. Similarly, in the case where a pooling layer is used, parameters of the pooling layer are also defined and optionally adapted during the training phase, and further included in the predictive model transmitted at step 625.

In order to improve the efficiency and/or accuracy of the training, the training data received at step 610 may be received from several smart thermostats 100 involved in the training. In the case where these smart thermostats 100 are deployed in several areas, a temperature sensor 500 also need to be deployed in each of the several areas. For each set of training data transmitted by a smart thermostat 100 located in a given area, a corresponding sensor temperature measurement is transmitted by the temperature sensor 500 located in the given area (as per step 615).

Optionally, the inputs include additional parameters used at step 620 of the method 600. For example (as mentioned previously in reference to the method 400), the smart thermostat 100 further comprises at least one additional component generating heat. At step 610, the training data further comprise a plurality of consecutive utilization metrics of the at least one additional component of the smart thermostat 100. At step 620, the inputs further comprise the plurality of consecutive utilization metrics of the at least one additional component. For instance, the additional component is the communication interface 130 of the smart thermostat 100.

Optionally, the output also include additional parameter(s) used at step 620 of the method 600.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A thermostat comprising:
a temperature sensing module;
a display;
memory for storing a predictive model comprising weights of a neural network; and
a processing unit comprising one or more processor configured to:
receive a plurality of consecutive temperature measurements from the temperature sensing module;
determine a plurality of consecutive utilization metrics of the one or more processor of the processing unit;
determine a plurality of consecutive utilization metrics of the display; and
execute a neural network inference engine using the predictive model for inferring one or more output based on inputs, the inputs comprising the plurality of consecutive temperature measurements, the plurality of consecutive utilization metrics of the one or more processor and the plurality of consecutive utilization metrics of the display, the one or more output comprising an inferred temperature.

2. The thermostat of claim 1 further comprising a communication interface, wherein the predictive model is received from a training server via the communication interface.

3. The thermostat of claim 1, wherein the utilization metric of the one or more processor of the processing unit is calculated based on a Central Processing Unit (CPU) utilization of each of the one or more processor.

4. The thermostat of claim 1, wherein the utilization metric of the display is calculated based on a pulse-width-modulation (PWM) voltage controlling the display.

5. The thermostat of claim 1, wherein the utilization metric of the display is calculated based on a measurement of an illumination in an area where the thermostat is located, the measurement of the illumination in the area being performed by an illumination sensor of the thermostat.

6. The thermostat of claim 1, further comprising at least one additional component generating heat, wherein the processing unit further determines a plurality of consecutive utilization metrics of the at least one additional component and the inputs further comprise the plurality of consecutive utilization metrics of the at least one additional component.

7. The thermostat of claim 6, wherein the at least one additional component comprises a communication interface of the thermostat.

8. The thermostat of claim 1, wherein the neural network inference engine implements a neural network comprising an input layer, followed by fully connected hidden layers, followed by an output layer; the input layer comprising neurons respectively receiving the plurality of consecutive temperature measurements, the plurality of consecutive utilization metrics of the one or more processor and the plurality of consecutive utilization metrics of the display; the output layer comprising a neuron outputting the inferred temperature; the weights of the predictive model being applied to the fully connected hidden layers.

9. The thermostat of claim 1, wherein the neural network inference engine implements a neural network comprising one input layer, followed by at least one one-dimensional convolutional layer, followed by fully connected hidden layers, followed by an output layer; the input layer comprising 3 neurons respectively receiving a one-dimension matrix, each one-dimension matrix respectively comprising the plurality of consecutive temperature measurements, the plurality of consecutive utilization metrics of the one or more processor and the plurality of consecutive utilization metrics of the display; the at least one one-dimensional convolutional layer applying a one-dimensional convolution to each one-dimension matrix; the output layer comprising a neuron outputting the inferred temperature; the weights of the predictive model being applied to the fully connected hidden layers and the predictive model further comprising parameters for the at least one one-dimensional convolutional layer.

10. The thermostat of claim 9, wherein the neural network further comprises at least one pooling layer.

11. The thermostat of claim 1, wherein the neural network inference engine implements a neural network comprising an input layer, followed by at least one two-dimensional convolutional layer, followed by fully connected hidden layers, followed by an output layer; the input layer comprising one neuron receiving a two-dimensions matrix comprising the plurality of consecutive temperature measurements, the plurality of consecutive utilization metrics of the one or more processor and the plurality of consecutive utilization metrics of the display; the at least one two-dimensional convolutional layer applying a two-dimensional convolution to the two-dimensions matrix; the output layer comprising a neuron outputting the inferred temperature; the weights of the predictive model being applied to the fully connected hidden layers and the predictive model further comprising parameters for the at least one two-dimensional convolutional layer.

12. The thermostat of claim 11, wherein the neural network further comprises at least one pooling layer.

13. The thermostat of claim 1, wherein the temperature sensing module further measures a humidity level and the processing unit adjusts the measured humidity level based on the inferred temperature.

14. A method using a neural network to adjust temperature measurements, the method comprising:
storing a predictive model comprising weights of the neural network in a memory of a computing device;
receiving by a processing unit of the computing device a plurality of consecutive temperature measurements from a temperature sensing module of the computing device, the processing unit comprising one or more processor;
determining by the processing unit of the computing device a plurality of consecutive utilization metrics of the one or more processor of the processing unit;
determining by the processing unit of the computing device a plurality of consecutive utilization metrics of a display of the computing device; and
executing by the processing unit of the computing device a neural network inference engine using the predictive model for inferring one or more output based on inputs, the inputs comprising the plurality of consecutive temperature measurements, the plurality of consecutive utilization metrics of the one or more processor and the plurality of consecutive utilization metrics of the display, the one or more output comprising an inferred temperature.

15. The method of claim 14, wherein the computing device is a thermostat.

16. The method of claim 14, further comprising receiving the predictive model via a communication interface of the computing device from a training server.

17. The method of claim 14, wherein the utilization metric of the one or more processor of the processing unit is calculated based on a Central Processing Unit (CPU) utilization of each of the one or more processor.

18. The method of claim 14, wherein the utilization metric of the display is calculated based on a pulse-width-modulation (PWM) voltage controlling the display.

19. The method of claim 14, wherein the utilization metric of the display is calculated based on a measurement of an illumination in an area where the thermostat is located, the measurement of the illumination in the area being performed by an illumination sensor of the thermostat.

20. The method of claim 14, wherein the computing device further comprises at least one additional component generating heat, the method further comprises determining a plurality of consecutive utilization metrics of the at least one additional component, and the inputs further comprise the plurality of consecutive utilization metrics of the at least one additional component.

21. The method of claim 20, wherein the at least one additional component comprises a communication interface of the computing device.

22. The method of claim 14, wherein the neural network inference engine implements a neural network comprising an input layer, followed by fully connected hidden layers, followed by an output layer; the input layer comprising neurons respectively receiving the plurality of consecutive temperature measurements, the plurality of consecutive utilization metrics of the one or more processor and the plurality of consecutive utilization metrics of the display; the output layer comprising a neuron outputting the inferred temperature; the weights of the predictive model being applied to the fully connected hidden layers.

23. The method of claim 14, wherein the neural network inference engine implements a neural network comprising one input layer, followed by at least one one-dimensional convolutional layer, followed by fully connected hidden layers, followed by an output layer; the input layer comprising 3 neurons respectively receiving a one-dimension matrix, each one-dimension matrix respectively comprising the plurality of consecutive temperature measurements, the plurality of consecutive utilization metrics of the one or more processor and the plurality of consecutive utilization metrics of the display; the at least one one-dimensional convolutional layer applying a one-dimensional convolution to each one-dimension matrix; the output layer comprising a neuron outputting the inferred temperature; the weights of the predictive model being applied to the fully connected hidden layers and the predictive model further comprising parameters for the at least one one-dimensional convolutional layer.

24. The method of claim 23, wherein the neural network further comprises at least one pooling layer.

25. The method of claim 14, wherein the neural network inference engine implements a neural network comprising an input layer, followed by at least one two-dimensional convolutional layer, followed by fully connected hidden layers, followed by an output layer; the input layer comprising one neuron receiving a two-dimensions matrix comprising the plurality of consecutive temperature measurements, the plurality of consecutive utilization metrics of the one or more processor and the plurality of consecutive utilization metrics of the display; the at least one two-dimensional convolutional layer applying a two-dimensional convolution to the two-dimensions matrix; the output layer comprising a neuron outputting the inferred temperature; the weights of the predictive model being applied to the fully connected hidden layers and the predictive model further comprising parameters for the at least one two-dimensional convolutional layer.

26. The method of claim 25, wherein the neural network further comprises at least one pooling layer.

27. The method of claim 14, wherein the temperature sensing module of the computing device further measures a humidity level and the processing unit module of the computing device adjusts the measured humidity level based on the inferred temperature.

28. A method for training a neural network to adjust temperature measurements, the method comprising:
(a) initializing by a processing unit of a training server a predictive model comprising weights of the neural network;
(b) receiving by the processing unit of the training server via a communication interface of the training server a plurality of consecutive temperature measurements from a computing device, the plurality of consecutive temperature measurements being performed by a temperature sensing module of the computing device;
(c) receiving by the processing unit of the training server via the communication interface of the training server a plurality of consecutive utilization metrics of one or more processor of the computing device;
(d) receiving by the processing unit of the training server via the communication interface of the training server a plurality of consecutive utilization metrics of a display of the computing device;
(e) receiving by the processing unit of the training server via the communication interface of the training server a sensor temperature measurement from a temperature sensor; and
(f) executing by the processing unit of the training server a neural network training engine to adjust the weights of the neural network based on inputs and one or more output, the inputs comprising the plurality of consecutive temperature measurements, the plurality of consecutive utilization metrics of the one or more processor and the plurality of consecutive utilization metrics of the display, the one or more output comprising the sensor temperature measurement.

29. The method of claim 28, wherein the computing device is a thermostat comprising the temperature sensing module, the one or more processor and the display.

30. The method of claim 28, wherein the computing device and the temperature sensor are deployed in the same area of a building.

31. The method of claim 28, wherein steps (b), (c), (d), (e) and (f) are repeated.

32. The method of claim 31, wherein the predictive model comprising the weights is transmitted to at least one of the computing device and other computing devices via a communication interface of the training server after a plurality of repetitions of steps (b), (c), (d), (e) and (f).

33. The method of claim 31, wherein the inputs are received from a plurality of computing devices.

34. The method of claim 28, wherein the utilization metric of the one or more processor of the computing device is calculated based on a Central Processing Unit (CPU) utilization of each of the one or more processor.

35. The method of claim 28, wherein the utilization metric of the display of the computing device is calculated based on a pulse-width-modulation (PWM) voltage controlling the display.

36. The method of claim 28, wherein the computing device further comprises at least one additional component generating heat, the method further comprises receiving by the processing unit of the training server via the communication interface of the training server a plurality of consecutive utilization metrics of the at least one additional component of the computing device, and the inputs further comprise the plurality of consecutive utilization metrics of the at least one additional component.

37. The method of claim 36, wherein the at least one additional component comprises a communication interface of the computing device.

38. The method of claim 28, wherein the neural network training engine implements a neural network comprising an input layer, followed by fully connected hidden layers, followed by an output layer; the input layer comprising neurons respectively receiving the plurality of consecutive temperature measurements, the plurality of consecutive utilization metrics of the one or more processor of the computing device and the plurality of consecutive utilization metrics of the display; the output layer comprising a neuron outputting the sensor temperature measurement; the weights of the predictive model being applied to the fully connected hidden layers.

39. The method of claim 28, wherein the neural network inference engine implements a neural network comprising one input layer, followed by at least one one-dimensional convolutional layer, followed by fully connected hidden layers, followed by an output layer; the input layer comprising 3 neurons respectively receiving a one-dimension matrix, each one-dimension matrix respectively comprising the plurality of consecutive temperature measurements, the plurality of consecutive utilization metrics of the one or more processor of the computing device and the plurality of consecutive utilization metrics of the display; the at least one one-dimensional convolutional layer applying a one-dimensional convolution to each one-dimension matrix; the output layer comprising a neuron outputting the sensor temperature measurement; the weights of the predictive model being applied to the fully connected hidden layers and the predictive model further comprising parameters for the at least one one-dimensional convolutional layer.

40. The method of claim 39, wherein the neural network further comprises at least one pooling layer.

41. The method of claim 28, wherein the neural network inference engine implements a neural network comprising an input layer, followed by at least one two-dimensional convolutional layer, followed by fully connected hidden layers, followed by an output layer; the input layer comprising one neuron receiving a two-dimensions matrix comprising the plurality of consecutive temperature measurements, the plurality of consecutive utilization metrics of the one or more processor of the computing device and the plurality of consecutive utilization metrics of the display; the at least one two-dimensional convolutional layer applying a two-dimensional convolution to the two-dimensions matrix; the output layer comprising a neuron outputting the sensor temperature measurement; the weights of the predictive model being applied to the fully connected hidden layers and the predictive model further comprising parameters for the at least one two-dimensional convolutional layer.

42. The method of claim 41, wherein the neural network further comprises at least one pooling layer.
